(19) United States
(12) Patent Application Publication
(10) Pub. No.: US 2005/0016913 A1
(43) Pub. Date: Jan. 27, 2005

(54) Apparatus for separating amalgam

(76) Inventors: Frank Giesel, Vogelsdorf (DE); Petra Schengber, Beuna (DE)

Correspondence Address: BIRCH STEWART KOLASCH & BIRCH, PO BOX 747, FALLS CHURCH, VA, 22040-0747, US

(21) Appl. No.: 10/765,962

(22) Filed: Jan. 29, 2004

(30) Foreign Application Priority Data
Jul. 22, 2003 (DE) 103 33 884.5

(51) Int. Cl. B01D 25/00

(52) U.S. Cl. 210/322

(57) ABSTRACT

The invention relates to an apparatus for separating amalgam from dental sewage. The object of the invention is to provide an apparatus for separating amalgam comprising an easily producible sedimentation surface, allowing to separate the deposited amalgam from the apparatus in a very effective manner by recycling the complete apparatus and enabling a level measuring without using external instruments.

The solution of this task arises from an apparatus, characterised in that the housing (10), which comprises an inlet chamber (40), a passage chamber (50) containing a separator (30) made of foils, and an outlet chamber (60), is sealed in a liquid-proof manner, except for a sewage inlet (41) and a sewage outlet (61), and provides stands. (13, 14), wherein the hollow interior of such stands (13, 14) contains at least one pressure chamber (72) which is combined with pressure sensors (75, 76) measuring any pressure changes.

The invention relates to an apparatus for separating amalgam in accordance with the preamble of Patent Claim 11.

Dental amalgams are metal compounds of mercury, silver, zinc, copper. Due to their good physical properties amalgams are used to make fillings in dentistry. Whenever teeth are filled with amalgam fillings or when such fillings are drilled out to remove them amalgam waste occurs. Together with the rinsing water and the saliva sucked out from the patient's mouth such amalgam waste is transferred into the dentist's sewage system. In order to prevent such heavy metals from entering the waste water treatment system such amalgam particles need to be removed before entering the public sewerage system.

The use of centrifuges is known which separate amalgam particles from the sewage due to the higher density of such particles. The disadvantage when using centrifuges is that they need to be switched off at certain intervals in order to allow the draining of precipitation from the drums. In addition to this centrifugal separators require expensive technological equipment. They include moving parts, such as a rapidly rotating motor. The method is expensive and requires a high amount of maintenance. A permanent power supply is necessary. The collecting containers of the separator must be regularly exchanged and their contents disposed of.

Also known are filtering separators which filter out the solid to be removed, such as amalgam in this case, from the dental sewage. Since amalgam contains a very high percentage of finest grain, the filters have the disadvantageous tendency to get choked and clogged very quickly.

Sedimentation separators use the settling characteristics of the relatively heavy amalgam particles. They provide an essentially horizontal water flow, the speed of which must be small enough as to allow the particles to deposit on the sedimentation surface due to their settling speed during their residence time. This requires short settling distances and large sedimentation surfaces. Amalgam sinks to the sedimentation surface and deposits there. The flow rate of the dental sewage must be low enough to ensure that the particles are not rinsed off the sedimentation surface again. To ensure the separating effect a maximum water flow must be determined.

WO 98/46 324 specifies an apparatus for separating solids from liquids by sedimentation, particularly for separating amalgam from water. This apparatus comprises a housing with flow and sedimentation zones. The sedimentation zone consists of a higher number of plates which are arranged horizontally and parallel to each other and whose surfaces provide extrusions and indentations which keep the plates at fixed distances to each other. Sewage is lead through the spaces between the plates in a laminar flow. During such passage the amalgam particles sediment on the surface of the plates. This apparatus is designed for multiple use and has the disadvantage, that the cleaning, i.e. the removal of the deposited amalgam particles from the plates, requires high efforts. The production of the plate package made of special steel is very expensive and cost-intensive. According to the regulation the separator must be provided with a level meter. In this case the load amount is determined in that the complete separator is put on an external balance to measure the amount of deposited amalgam. This increases the costs of amalgam separation in a dentist's practise.

The object of the invention is to provide an apparatus for separating amalgam comprising an easily producible sedimentation surface, allowing to separate the deposited amalgam from the apparatus in a very effective manner by recycling the complete apparatus and enabling a level measuring without using external instruments.

The solution of this task arises from the characteristics of Patent Claim 1. Advantageous embodiments are specified in the sub-claims.

So the apparatus according to the invention for separating amalgam from dental sewage, consisting of a flow zone and a sedimentation zone, which are arranged in a housing providing an aperture for sewage supply and an aperture for sewage discharge, characterised in that the housing, which comprises an inlet chamber, a passage chamber which contains a separator made of foil layers, and an outlet chamber, is sealed in a liquid-proof manner, except for a sewage inlet and a sewage outlet, and provides stands, whereby in an advantageous embodiment the hollow interior of such stands contains at least one pressure chamber which is combined with pressure sensors measuring any pressure changes.

In an embodiment of the invention the inlet chamber, the passage chamber with the separator and the outlet chamber are arranged horizontally one after the other seen in flow direction, and with the sewage inlet and the sewage outlet arranged in the highest position of the inlet chamber and the outlet chamber respectively.

In an embodiment of the invention the separator is a form body which can be streamed through consisting of several tight fitting layers of a structured foil.

In another embodiment of the invention the separator is a form body which can be streamed through consisting of several tight fitting layers of a structured foil and a plain foil that are arranged alternatingly.

According to another embodiment of the invention the separator forming a form body consists of a wound structured foil or a structured foil wound in combination with a plain foil such that by simple winding of both foils, or only of the structured foil, a form body is created which can be streamed through in the longitudinal direction.

In another embodiment of the invention the separator forming a form body consists of tubular elements made of structured foil, or structured foil and plain foil, which are slit into each other.

In further embodiments of the invention the longitudinal structures are formed by different plisse structures such as triangles, quadrangles or trapezia. Furthermore it is also possible to use lamellar, honeycombed or riffle structures.

It is also preferred to form structured foil in a way such that only scattered raised points or indentations are provided. Other structures which are not explicitly named here and also have a distance-keeping effect shall of course also be covered by the term structured foil. The optimum distances between the foil layers are between 1 and 10 mm.

In another embodiment the sedimentation surfaces of the structured foil are roughened in order to achieve an even better sedimentation of amalgam particles.

In another embodiment of the invent-ion a perforated plate is arranged between the inlet chamber and the passage chamber, the holes of which provide sinkings on the side that faces the flow.

Another essential advantage according to an embodiment of the invention is a flow guidance element provided in the inlet chamber that is arranged in the upper area of the inlet chamber. Thus, in combination with the perforated plate a laminar flow is generated in the flow channels of the separator over the complete height of the housing. This allows to completely fill the housing with water without leaving dead space. Furthermore this ensures an advantageous water trap effect.

In another embodiment of the invention, in the uppermost position of the passage chamber above the separator a vent channel is arranged which has a connection to the sewage outlet in the outlet chamber. This enables any gases forming in connection with the flow guidance or any inclusions of air to gather in this vent channel and to be removed from the apparatus directly via the sewage outlet.

A further embodiment provides a flow regulator in the sewage outlet.

In a particular embodiment of the invention the pressure chamber located in a stand comprises a gas-impermeable, elastic foil which bulges outward after being filled with air or another gas up to a slight excess pressure, so that when the mass of the apparatus increases due to the deposition of amalgam the foil is compressed thus generating a higher measurable pressure inside the pressure chamber which serves as the measure for the level indicator. This requires that the level meter is connected with the pressure chamber in a pressure-sensory manner.

The apparatus according to the invention consists of recyclable synthetic material. It can be shreddered and recycled completely after the amalgam was separated.

In the following the invention will be explained in detail by means of an embodiment and drawings.

In the figures

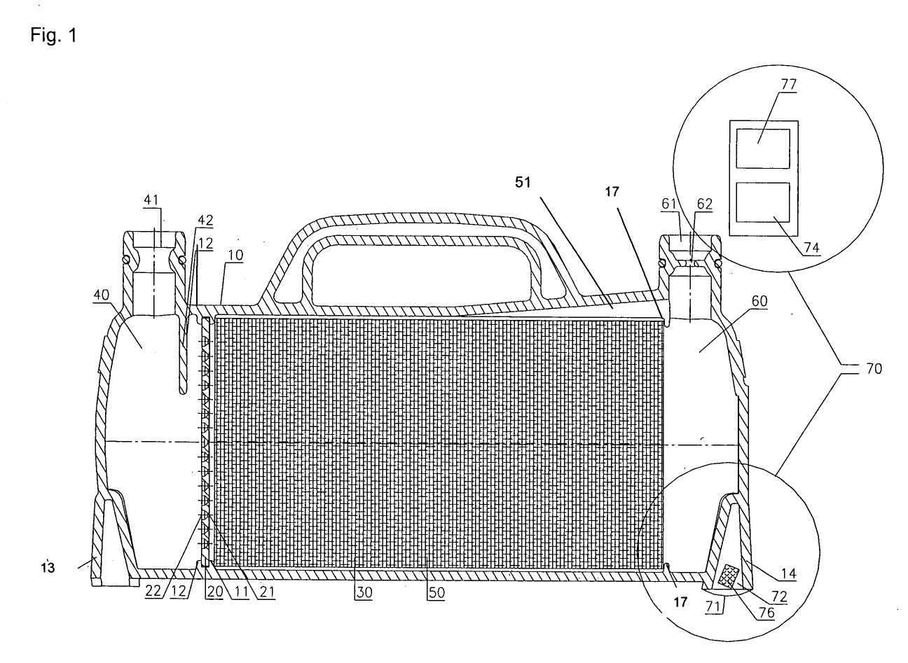

FIG. 1 shows a schematic longitudinal section of the apparatus with a wireless transmitting level indicator,

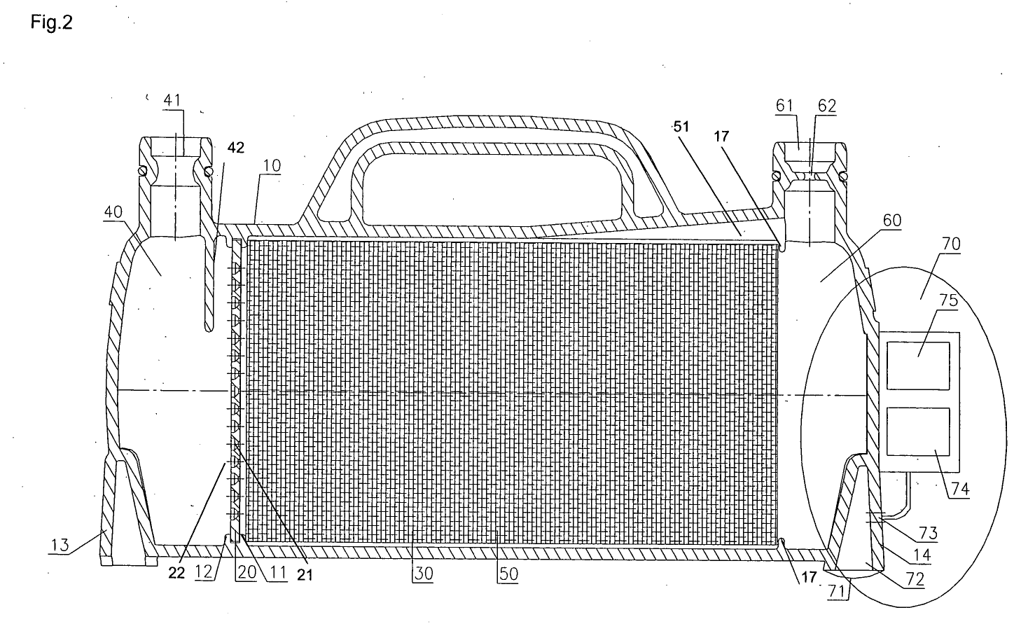

FIG. 2 shows a schematic longitudinal section of the apparatus with an exterior level indicator located close to the outside of the apparatus,

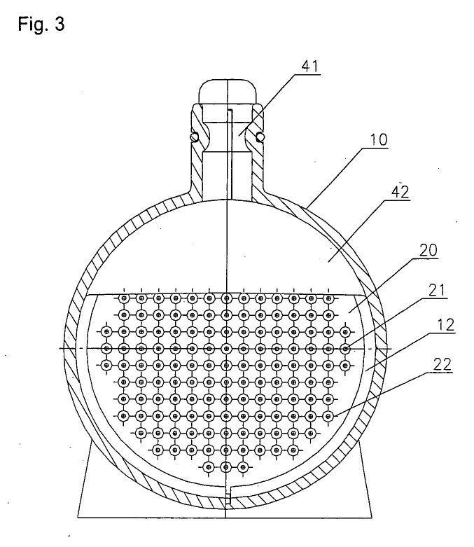

FIG. 3 shows a cross section of the inlet chamber of the separator as seen in flow direction,

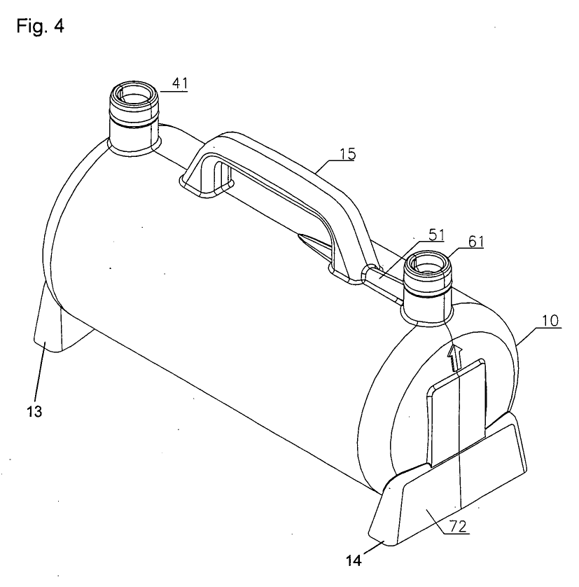

FIG. 4 shows a perspective exemplary illustration of the whole apparatus,

FIG. 5 shows a perspective illustration of the longitudinal cross-section of the housing of the apparatus,

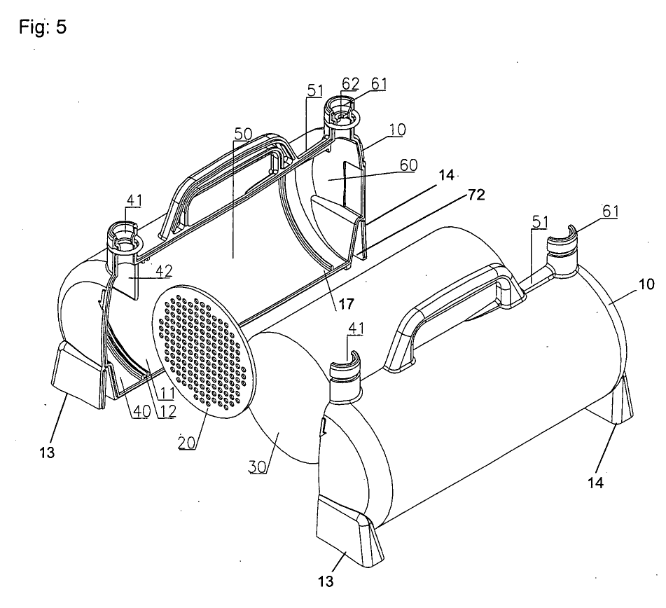

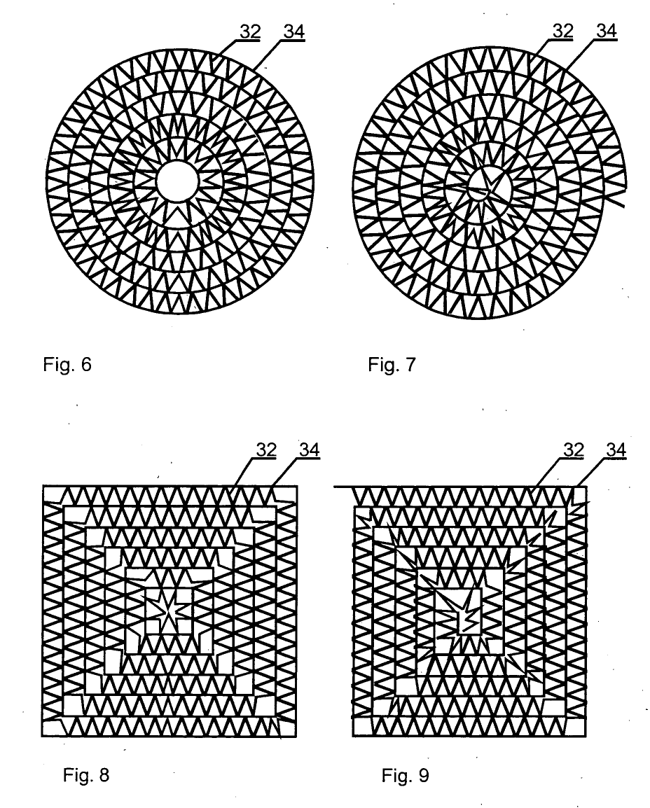

FIG. 6 shows a schematic illustration of the separator consisting of tubular elements made of structured foil and plain foil, which are slit into each other,

FIG. 7 shows a schematic cross-sectional illustration of the separator in the wound-up version,

FIG. 8 shows a schematic cross-sectional illustration of the separator with a square cross-sectional area using separate tubular elements,

FIG. 9 shows a schematic cross-sectional illustration of the separator in the wound-up version with a square cross section,

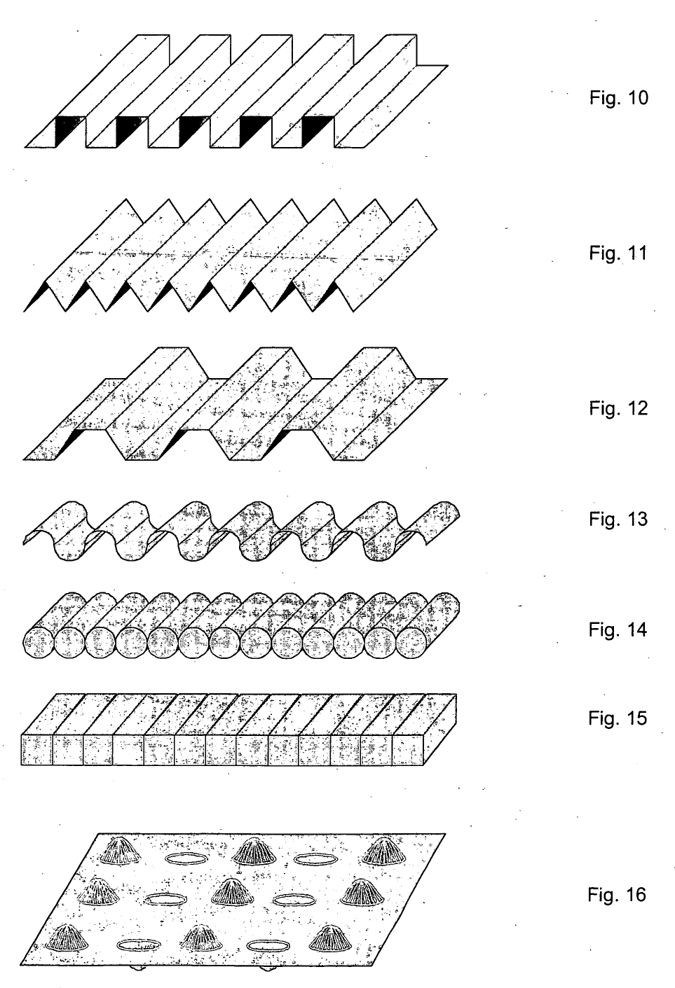

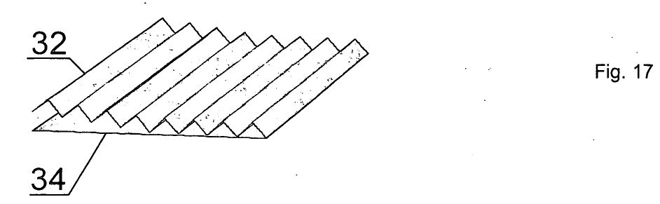

FIG. 10 to FIG. 16 show various embodiments of structured foil,

FIG. 17 shows a schematic illustration of a combination of structured foil and plain foil,

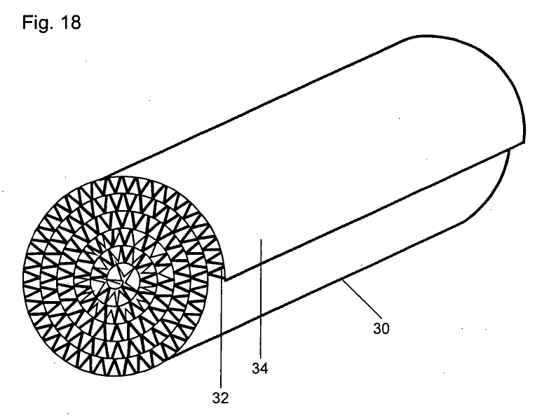

FIG. 18 shows a schematic perspective illustration of a separator, and

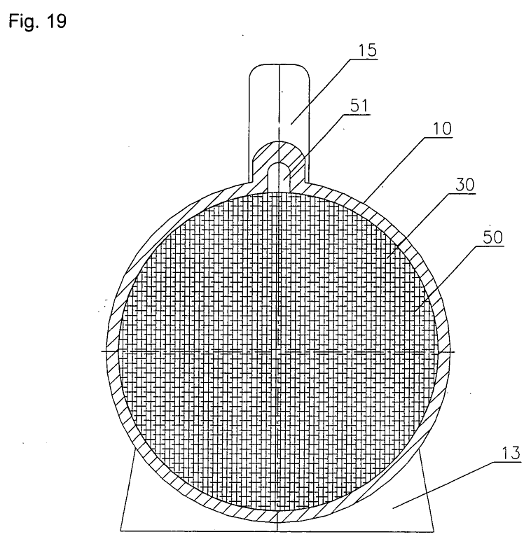

FIG. 19 shows a cross section of the outlet chamber as seen against the flow direction.

FIG. 1 shows a schematic longitudinal section of the apparatus according to the invention. Provided in the interior of a housing 10 are an inlet chamber 40, a passage chamber 50 and an outlet chamber 60. The housing 10 provides a handle 15 that allows the easy transport of the apparatus. A stand (front) 13 and a stand (rear) 14 are arranged at the bottom area of the housing 10, ensuring a secure position of the apparatus. A sewage inlet 41 allows the sewage to enter the inlet chamber 40. A flow element 42 extending into the inlet chamber from above, which restricts the passage area by approximately 30 %, enables the formation of a siphon-like water trap.

Sewage penetrates then through a perforated plate 20 in which a higher number of holes 21 is arranged scattered over the surface of the perforated plate 20, which holes provide sinkings on the side that faces the flow. The perforated plate 20 is fixed by an attachment (front) 11 and an attachment (rear) 12. A separator 30 is located in the passage chamber 50 which is arranged behind the perforated plate 20. The separator 30 is fixed in the passage chamber 40 by the attachment (rear) and a retaining edge 17. A vent channel 50 with a direct connection to the outlet chamber 60 is provided above the separator 30 in the passage chamber 50. This vent channel 51 which extends approximately from the middle of the passage chamber 50 to the outlet chamber 60 allows the gathering of any occurring gasses or inclusions of air which can then be discharged directly through a sewage outlet 61 of the outlet chamber 60.

A flow regulator 62 is located in the sewage outlet 61 which is arranged in the highest position of the outlet chamber 60.

A level meter 70 is arranged inside or outside of the housing 20. A pressure chamber 72 which is closed at the bottom by a gas-impermeable and elastic foil 71 is provided within the stand (rear) 14 as a part of such level meter. Due to the slightly pressurized gas filling the foil 71 is bulged outward such that the whole apparatus according to the invention stands on a kind of air cushion on one side, namely on the stand (rear) 14. The more amalgam deposits in the separator, the higher is the pressure on the bulging foil 71 thus increasing the pressure in the pressure chamber 72. The pressure increase is proportional to the mass increase of the apparatus.

A pressure sensor (wireless) 76 located in the pressure chamber 72 is provided with a radio transmitter which transmits the respective pressure data to a receiver 77 that is located outside the housing, and when a certain limit is reached an integrated alarm box 74 gives an acoustic or visual signal indicating that the apparatus is completely loaded with amalgam. In this case the complete apparatus is removed from the dental sewage network and taken to a waste disposal system where due to the given material and construction according to the invention the whole apparatus will be shreddered and the sedimented amalgam separated in an easy manner.

After removing the filled apparatus a new apparatus can be easily installed in the doctor's practise.

FIG. 2 shows a second version of level measuring, wherein via a pressure duct 73 extending through a wall 16 of the housing 10 any pressure changes occurring in the pressure chamber are directly transmitted to a pressure sensor 75 located on the outside, which carries out the necessary electronic processes that induce the alarm box 74 to indicate the maximum filling level of the apparatus.

FIG. 3 shows a cross section of the apparatus according to the invention with the cross section carried out before the perforated plate 20 as seen in flow direction. The holes 21 of the perforated plate 20 ensure that bigger particles contained in the dental sewage are retained in this place. The sinking 22 prevents here a clogging of the smaller holes 21. After the housing 10 is completely filled with water the flow guidance element 42 which is arranged directly behind the water inlet 41 acts as a water trap.

FIG. 4 shows by way of example a perspective illustration of the general view of an apparatus according to the invention depicting the sewage inlet 41, the sewage outlet 61 as well as the vent channel 51 and the pressure chamber 72. The handle 15 allows the easy transport of the apparatus.

The apparatus cannot be opened any more in this state. The amalgam is removed after the apparatus is destroyed completely, e.g. by shredding.

FIG. 5 shows also by way of example an exploded perspective view of the apparatus according to the invention. After the installation of the perforated plate 20 and the separator 30 the two halves of the housing 10 depicted here are bonded or sealed to each other. An option for opening the apparatus is not provided because the complete apparatus once filled with a maximum amount of amalgam is replaced by a new apparatus, while the filled apparatus will be shreddered, the amalgam separated and all the material recycled.

The form depicted in FIG. 4 and FIG. 5 in perspective illustration is a preferred cylindrical form, as the manufacturing of the cylindrical form of the separator 30 formed of structured foil 32 and plain foil 34 is particularly advantageous. The housing 10 that is depicted here can be produced in different ways, particularly preferred is injection moulding. The housing 10 comprises the preformed inlet chamber 40, passage chamber 50 and outlet chamber 60, whereby the perforated plate 20 is fixed between the attachment (front) 12 and the attachment (rear) 11 and the separator 30 is installed in the passage chamber 50. Also in the cylindrical version, the upper section of the housing 10 provides the sewage inlet 41 and the sewage outlet 61 at the ends of the cylindrical form which due to their shape can be connected by means of sewage tubes or pipes. The vent channel 51 arching upward extends from the middle of the housing 10 to the sewage outlet 61 to ensure that occurring gasses or trapped air can enter the sewage outlet 61 easily. The external stand (front) 13 and the stand (rear) 14 ensure the stability of the apparatus. According to the invention a pressure chamber 72 is arranged in the hollow spaces provided in such stands, and this pressure chamber 72 as part of the level meter 70 enables an exact loading density with amalgam.

FIG. 6 to FIG. 9 depict cross-sectional versions of the separator 30 made of a structured foil 32 and a plain foil 34.

FIG. 6 and FIG. 8 show particularly those combinations of the structured foil 32 and the plain foil 34 which are made of tubular elements which were slit into each other, while FIG. 7 and FIG. 9 show versions where the two combined foils, the structured foil 32 and the plain foil 34, are wound up.

FIG. 10 to FIG. 16 show by way of example various types of the structured foil 32, which can be combined with a plain foil 34, as depicted in FIG. 17, by putting one foil on top of the other and subsequently winding up the two foils until the separator 30 has the form required to ensure that when introducing it into the passage chamber 50 the latter is filled completely. This form is depicted, for example, in FIG. 18 in a perspective view.

FIG. 19 depicts a cross section of the apparatus as seen against the flow direction of the sewage, showing the separator 30 when introduced in the passage chamber 50. Arranged above the separator 30 is the vent channel 51 as a protrusion of the housing 10.

### List of Reference Numerals

10 housing
11 attachment (rear)
12 attachment (front)
13 stand (front)
14 stand (rear)
15 handle
16 wall
17 retaining edge
20 perforated plate
21 hole
22 sinking
30 separator
31 flow channel
32 structured foil
33 wall
34 plain foil
40 inlet chamber
41 sewage inlet
42 flow guidance element
50 passage chamber
51 vent channel
60 outlet chamber
61 sewage outlet
62 flow regulator
70 level meter
71 foil
72 pressure chamber
73 pressure duct
74 alarm box
75 pressure sensor
76 pressure sensor(wireless)
77 receiver

1. An apparatus for separating amalgam from dental sewage,
consisting of a flow zone and a sedimentation zone which are arranged in a housing providing an aperture for sewage supply and an aperture for sewage discharge,
characterised in that
the housing (10), which comprises an inlet chamber (40), a passage chamber (50) containing a separator (30) made of foils, and an outlet chamber (60), is sealed in a liquid-proof manner, except for a sewage inlet (41) and a sewage outlet (61), and provides stands (13, 14).

2. An apparatus according to claim 1,
characterised in that
the hollow interior of such stands (13, 14) contains at least one pressure chamber (72) which is combined with pressure sensors (75, 76) measuring any pressure changes.

3. An apparatus according to claims 1 or 2,
characterised in that
the inlet chamber (40), the passage chamber (50) with the separator (30) and the outlet chamber (60) are arranged horizontally one after the other as seen in flow direction, and with the sewage inlet (41) and the sewage outlet (61) arranged in the highest position of the inlet chamber (40) and the outlet chamber (60) respectively.

4. An apparatus according to claim 1,
characterised in that
the separator (30) is a form body which can be streamed through consisting of several tight fitting layers of a structured foil (32).

5. An apparatus according to claim 1,
characterised in that
the separator (30) is a form body which can be streamed through consisting of several tight fitting layers of a structured foil (32) and a plain foil (34) that are arranged alternatingly.

6. An apparatus according to claim 1,
characterised in that
the separator (30) forming a form body consists of a wound structured foil (32) or a structured foil (32) wound in combination with a plain foil (34).

7. An apparatus according to claim 1,
characterised in that
the separator (30) forming a form body consists of tubular elements made of structured foil (32), or structured foil (32) and plain foil (34), which are slit into each other.

8. An apparatus according to claim 1,
characterised in that
the structured foil (32) provides continuous longitudinal structures as seen in the flow direction of the sewage.

9. An apparatus according to claim 1,
characterised in that
the structured foil (32) provides a plisse structure consisting of triangles, quadrangles, trapezia.

10. An apparatus according to claim 1,
characterised in that
the structured foil (32) provides lamellar, honeycombed or riffle structures or scattered raised points or indentations.

11. An apparatus according to claim 1,
characterised in that
the sedimentation surfaces of the structured foil (32) are roughened.

12. An apparatus according to claim 1,
characterised in that
a perforated plate (20) is arranged between the inlet chamber (40) and the passage chamber (50), the holes (21) of which provide sinkings (22) on the side that faces the flow.

13. An apparatus according to claim 1,
characterised in that
the inlet chamber (40) provides a flow guidance element (42) that is arranged in the upper area of the inlet chamber (40).

14. An apparatus according to claim 1,
characterised in that
in the uppermost position of the passage chamber (50), above the separator (30), a vent channel (51) is arranged which has a connection to the sewage outlet (61) in the outlet chamber (60).

15. An apparatus according to claim 1,
characterised in that
the sewage outlet (61) provides a flow regulator (62).

16. An apparatus according to claim 1,
characterised in that
the pressure chamber (72) provided in a stand (13, 14) comprises a gas-impermeable, elastic foil (71).

17. An apparatus according to claim 1,
characterised in that
the pressure chamber (72) contains air or another gas and is slightly pressurized.

18. An apparatus according to claim 1,
characterised in that
the level meter (70) is connected with the pressure chamber (72) in a pressure-sensory manner.

19. An apparatus according to claim 1,
characterised in that
the cross-sectional are of the separator (30) is round, oval or square.

20. An apparatus according to claim 1,
characterised in that
the cross-sectional area of the housing (10) is round, oval or square.

21. An apparatus according claim 1,
characterised in that
the apparatus consists of recyclable synthetic material.
